(19) United States
(12) Patent Application Publication
(10) Pub. No.: US 2023/0280182 A1
(43) Pub. Date: Sep. 7, 2023

(54) HIGH-PRECISION MAP DATA COLLECTION METHOD AND APPARATUS, ELECTRONIC DEVICE, AND STORAGE MEDIUM

(71) Applicant: BEIJING BAIDU NETCOM SCIENCE TECHNOLOGY CO., LTD., Beijing (CN)

(72) Inventors: Tianxiong DUAN, Beijing (CN); Baofeng MA, Beijing (CN); Daochen CHONG, Beijing (CN); Yuting LIU, Beijing (CN)

(73) Assignee: BEIJING BAIDU NETCOM SCIENCE TECHNOLOGY CO., LTD., Beijing (CN)

(21) Appl. No.: 18/055,381

(22) Filed: Nov. 14, 2022

(30) Foreign Application Priority Data
Mar. 7, 2022 (CN) 202210217319.4

(51) Int. Cl. G01C 21/00; G01C 21/32

(52) U.S. Cl. CPC G01C 21/3841; G01C 21/32

(57) ABSTRACT

Provided are a high-precision map data collection method and apparatus, an electronic device, and a storage medium, relating to the field of data processing technology and, in particular, to the field of self-driving technology. The solution includes acquiring high-precision map data collected by a data collection device at a target time; and determining the satellite navigation system time corresponding to the target time and establishing an association between the high-precision map data and the satellite navigation system time.

### CROSS-REFERENCE TO RELATED APPLICATION

This application claims priority to Chinese Patent Application No. CN202210217319.4, filed on Mar. 7, 2022, the disclosure of which is incorporated herein by reference in its entirety.

### TECHNICAL FIELD

The present disclosure relates to the field of data processing technology, particularly the field of self-driving technology, for example, a high-precision map data collection method and apparatus, an electronic device, a storage medium, and a computer program product.

### BACKGROUND

A high-precision map is an electronic map with a higher precision and more data dimensions. The higher precision is represented by centimeter-level precision. More data dimensions are represented by the inclusion of surrounding static information related to traffic in addition to road information. As an important part of a self-driving system, a high-precision map is one of the key factors promoting the development of self-driving.

### SUMMARY

The present disclosure provides a high-precision map data collection method and apparatus, an electronic device, a storage medium, and a computer program product.

According to an aspect of the present disclosure, a high-precision map data collection method is provided. The method includes acquiring high-precision map data collected by a data collection device at a target time; and determining the satellite navigation system time corresponding to the target time and establishing an association between the high-precision map data and the satellite navigation system time.

According to another aspect of the present disclosure, a high-precision map data collection apparatus is provided. The apparatus includes an acquisition module and an association recording module.

The acquisition module is configured to acquire high-precision map data collected by a data collection device at a target time.

The association recording module is configured to determine the satellite navigation system time corresponding to the target time and establish an association between the high-precision map data and the satellite navigation system time.

According to another aspect of the present disclosure, an electronic device is provided. The electronic device includes at least one processor; and a memory communicatively connected to the at least one processor.

The memory stores instructions executable by the at least one processor to enable the at least one processor to perform the high-precision map data collection method according to any embodiment of the present disclosure.

According to another aspect of the present disclosure, a non-transitory computer-readable storage medium storing computer instructions is provided. The computer instructions are configured to cause a computer to perform the high-precision map data collection method according to any embodiment of the present disclosure.

According to another aspect of the present disclosure, a computer program product including a computer program is provided. When the computer program is executed by a processor, the high-precision map data collection method according to any embodiment of the present disclosure is performed.

The technology of the present disclosure enables the collection time of the high-precision map data to synchronize with the satellite navigation system time and ensures the collection precision of the high-precision map data.

It is to be understood that the content described in this part is neither intended to identify key or important features of embodiments of the present disclosure nor intended to limit the scope of the present disclosure. Other features of the present disclosure are apparent from the description provided hereinafter.

### BRIEF DESCRIPTION OF DRAWINGS

The drawings are intended to provide a better understanding of the solution and not to limit the present disclosure.

FIG. 1 is a flowchart of a high-precision map data collection method according to an embodiment of the present disclosure.

FIG. 2 is a flowchart of another high-precision map data collection method according to an embodiment of the present disclosure.

FIG. 3 is a flowchart of another high-precision map data collection method according to an embodiment of the present disclosure.

FIG. 4 is a flowchart of another high-precision map data collection method according to an embodiment of the present disclosure.

FIG. 5 is a flowchart of another high-precision map data collection method according to an embodiment of the present disclosure.

FIG. 6 is a diagram illustrating the structure of a high-precision map data collection apparatus according to an embodiment of the present disclosure.

FIG. 7 is a block diagram of an electronic device for performing a high-precision map data collection method of an embodiment of the present disclosure.

### DETAILED DESCRIPTION

Example embodiments of the present disclosure, including details of embodiments of the present disclosure, are described hereinafter in conjunction with drawings to facilitate understanding. The example embodiments are illustrative only. Therefore, it is to be appreciated by those of ordinary skill in the art that various changes and modifications may be made to the embodiments described herein without departing from the scope and spirit of the present disclosure. Similarly, description of well-known functions and constructions is omitted hereinafter for clarity and conciseness.

In this embodiment of the present disclosure, a map collection apparatus for collecting high-precision map data is mounted on a collection vehicle (for example, an automobile). In a working state, the collection vehicle collects high-precision map data while running on a road. The map collection apparatus includes various data collection devices. The various data collection devices include an image collector detachably disposed on a first mounting post of a mounting platform, a lidar detachably disposed on a second mounting post of the mounting platform, and a combined navigation device detachably disposed on the base of the mounting platform. The image collector includes a front-facing camera and an omnidirectional camera. The mounting platform ensures that the various data collection devices can be mounted on the collection vehicle. The various data collection devices can be detached and thus can be easily repaired or replaced so that the work efficiency can be improved. Further, each data collection device includes a local clock so that each data collection device collects high-precision map data according to the respective local clock. As a result, the map collection apparatus has no uniform time scale and thus collects erroneous or lower-precision map data. In view of this, a high-precision map data collection method is provided in the present disclosure. The process of the method is described in the embodiments below.

FIG. 1 is a flowchart of a high-precision map data collection method according to an embodiment of the present disclosure. This embodiment is applicable to the case of time synchronization of a data collection device of a map collection apparatus. The method may be performed by a high-precision map data collection apparatus. The apparatus may be implemented in software and/or hardware and may be integrated in an AR electronic device.

Referring to FIG. 1, the high-precision map data collection method is described below.

In S101, high-precision map data collected by a data collection device at a target time is acquired.

In this embodiment of the present disclosure, the data collection device includes an image collector detachably disposed on a first mounting post of a mounting platform and a lidar detachably disposed on a second mounting post of the mounting platform. The image collector includes a front-facing camera and an omnidirectional camera. The omnidirectional camera includes a case and cameras spaced apart around the case. The case is detachably disposed at the top end of the first mounting post. The cameras are detachably connected to the case. The front-facing camera is disposed below the omnidirectional camera and has an adjustable pitch angle.

In this embodiment of the present disclosure, the target time is determined according to the local clock of the data collection device. Each time the data collection device completes collection of high-precision map data (for example, image data collected by the image collector and 3D point cloud data collected by the lidar), the target time of the collection is determined. Optionally, the target time is the time of mapping of the data collection device.

In S102, the satellite navigation system time corresponding to the target time is determined, and an association between the high-precision map data and the satellite navigation system time is established.

In this embodiment of the present disclosure, the satellite navigation system time corresponding to the target time may be the satellite navigation system time fed back by a navigation satellite and received at the target time; or the satellite navigation system time corresponding to the target time may be determined according to a predetermined time relationship between the target time and the satellite navigation system time. This is not limited herein. After the satellite navigation system time corresponding to the target time is obtained, the association between the satellite navigation system time and the high-precision map data collected at the target time is established. In this manner, the collection time of the high-precision map data synchronizes with the satellite navigation system time. That is, each data collection device has a uniform time scale so that the collection sequence of the high-precision map data collected by the data collection device is clear and so that the collected high-precision map data is prevented from being erroneous. Moreover, by synchronizing the collection time with the satellite navigation system time, the position of the high-precision map data can be determined according to the positioning data corresponding to the current satellite navigation system time so that the precision of the collected high-precision map data is ensured.

In this embodiment of the present disclosure, the collection time of the high-precision map data synchronizes with the satellite navigation system time so that the collected high-precision map data is prevented from being erroneous and so that the precision of the collected high-precision map data is ensured.

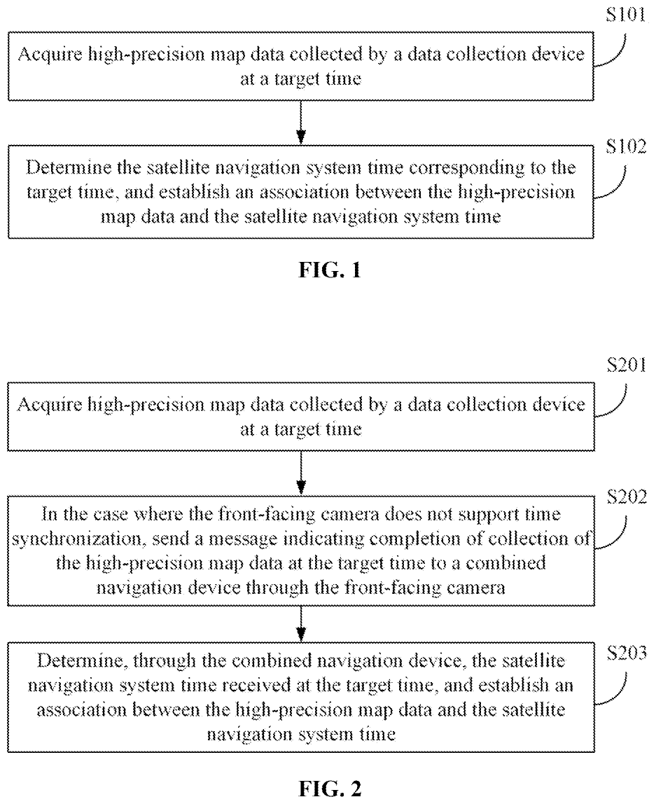

FIG. 2 is a flowchart of another high-precision map data collection method according to an embodiment of the present disclosure. With regard to the case where the front-facing camera as the data collection device does not support time synchronization, this embodiment of the present disclosure is a refinement of the previous embodiment. Referring to FIG. 2, the high-precision map data collection method is described below.

In S201, high-precision map data collected by a data collection device at a target time is acquired.

In this embodiment of the present disclosure, the data collection device is a front-facing camera by way of example.

In S202, in the case where the front-facing camera does not support time synchronization, a message indicating completion of collection of the high-precision map data at the target time is sent to a combined navigation device through the front-facing camera.

In S203, the satellite navigation system time received at the target time is determined through the combined navigation device, and an association between the high-precision map data and the satellite navigation system time is established.

In this embodiment of the present disclosure, the front-facing camera does not support time synchronization, that is, time synchronization cannot be performed on the front-facing camera according to the satellite navigation system time; therefore, the high-precision map data collected by the front-facing camera according to its own local clock is required to synchronize with the satellite navigation system time in other manners. In an implementation, a combined navigation device is disposed in the map collection apparatus. The combined navigation device may be composed of a satellite navigation module (for example, a Global Navigation Satellite System (GNSS) module) and an inertial navigation module (for example, an Inertial measurement unit (IMU) module). The combined navigation device is detachably disposed on the base of the mounting platform. The combined navigation device is configured to determine position and attitude data and receive, through an antenna in real time, the satellite navigation system time fed back by a navigation satellite.

In this embodiment of the present disclosure, since the front-facing camera does not support time synchronization, the front-facing camera may work in a proactively triggered mode. For example, the front-facing camera shoots at a fixed frequency. Once completing shooting one frame of high-precision map data at the target time, the front-facing camera sends a message indicating completion of collection of the high-precision map data at the target time to the combined navigation device. Optionally, the front-facing camera sends the message by sending a level signal to the combined navigation device. After obtaining the message, the combined navigation device determines the satellite navigation system time fed back by the navigation satellite and received at the target time; and records the information data, that is, establishes the association between the high-precision map data and the satellite navigation system time. The recorded data may then be fed back to an industrial personal computer so as to be processed and stored.

In this embodiment of the present disclosure, the interaction between the combined navigation device and the front-facing camera realize that, in the case where the front-facing camera does not support time synchronization, the collection time of the high-precision map data synchronizes with the satellite navigation system time, ensuring the accuracy and precision of the collected high-precision map data.

Further, in this embodiment of the present disclosure, the combined navigation device is also configured to determine position and attitude data involved when the high-precision map data is collected. Moreover, in a preset scenario (for example, a tunnel or elevated bridge that has poor or no satellite signal), the combined navigation device may also assist in positioning according to wheel speed information fed back by a wheel speedometer. In the preset scenario, the combined navigation device corrects a drift of the inertial navigation module of the combined navigation device by using the wheel speed information so that precise positioning of the device is achieved. The wheel speed information is obtained from signals acquired from the wheel speed sensor of a vehicle by the wheel speedometer and processed by the wheel speedometer, with no use of an external wheel speed measuring component. It is to be noted that the reason why no external wheel speed measuring component is used is the trouble of installation and the impact on the accuracy of signals. The trouble of installation lies in that different fixing mechanisms that are poor in universality are customized to adapt to different wheel hubs of different vehicle types. The impact on the accuracy of signals is caused by the proneness of an external wheel speed measuring component to collision, deformation, and damage by an external force.

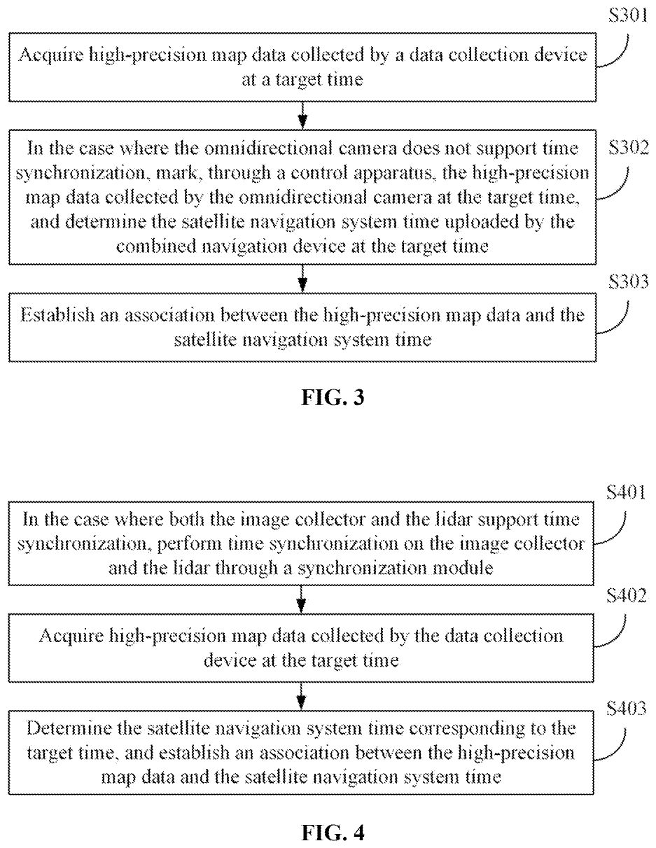

FIG. 3 is a flowchart of another high-precision map data collection method according to an embodiment of the present disclosure. With regard to the case where the omnidirectional camera as the data collection device does not support time synchronization, this embodiment of the present disclosure is a refinement of the previous embodiment. Referring to FIG. 3, the high-precision map data collection method is described below.

In S301, high-precision map data collected by a data collection device at a target time is acquired.

In this embodiment of the present disclosure, the data collection device is an omnidirectional camera by way of example.

In S302, in the case where the omnidirectional camera does not support time synchronization, the high-precision map data collected by the omnidirectional camera at the target time is marked through a control apparatus, and the satellite navigation system time uploaded by the combined navigation device at the target time is determined.

In S303, an association between the high-precision map data and the satellite navigation system time is established.

In this embodiment of the present disclosure, the collection vehicle is also provided with a control apparatus for managing the data collection device and the high-precision map data. The control apparatus includes an industrial personal computer, a display, and a memory (for example, a mobile hard disk). Collection software runs on the industrial personal computer to communicate with all the data collection devices to control the data collection devices and monitor the status of the devices. All the collected high-precision map data is stored in the disk, facilitating the transfer of the result data. A collection software interface is displayed on the display to show the operator the status of all the devices. Additionally, the industrial personal computer receives, in real time, the satellite navigation system time uploaded by the combined navigation device and position and attitude data corresponding to the satellite navigation system time.

In this embodiment of the present disclosure, the omnidirectional camera is communicatively connected to the industrial personal computer of the control apparatus via a hub. The hub includes a power supply module, a data communication module, and a control module. The power supply module is responsible for supplying power to the multiple cameras constituting the omnidirectional camera. The data communication module establishes a data communication link between the multiple cameras and the industrial personal computer. Before the omnidirectional camera starts collecting data, it is required to set shooting parameters (for example, an exposure parameter). The process of setting shooting parameters is as follows: The industrial personal computer sends a shooting instruction to the omnidirectional camera through the data communication module; the omnidirectional camera performs light measurement according to the shooting instruction and transmits the light measurement parameter back to the industrial personal computer through the data communication module; and the industrial personal computer synchronizes the shooting parameters for the multiple cameras through the data communication module, for example, sends the exposure parameter to the omnidirectional camera. It is to be noted that the exposure parameters of the individual cameras constituting the omnidirectional camera are the same. After settings of the shooting parameters are completed, the control module sends a trigger electric signal to the omnidirectional camera to trigger the omnidirectional camera to perform shooting. Further, when receiving the electric signal fed back by the omnidirectional camera and including the mapping time, the industrial personal computer marks the high-precision map data collected by the omnidirectional camera at the target time (that is, the mapping time), determines the satellite navigation system time uploaded by the combined navigation device at the target time, and then establishes the association between the high-precision map data and the satellite navigation system time. In this manner, the collection time of the high-precision map data synchronizes with the satellite navigation system time.

In this embodiment of the present disclosure, the interaction between the industrial personal computer, the combined navigation device, and the omnidirectional camera realizes that, in the case where the omnidirectional camera does not support time synchronization, the collection time of the high-precision map data synchronizes with the satellite navigation system time, ensuring the accuracy and precision of the collected high-precision map data.

FIG. 4 is a flowchart of another high-precision map data collection method according to an embodiment of the present disclosure. With regard to the case where the data collection device supports time synchronization, this embodiment of the present disclosure is a refinement of the previous embodiment. Referring to FIG. 4, the high-precision map data collection method is described below.

In S401, in the case where both the image collector and the lidar support time synchronization, time synchronization is performed on the image collector and the lidar through a synchronization module.

In this embodiment of the present disclosure, the synchronization module receives, in real time, the satellite navigation system time transmitted in real time by the combined navigation device and controls, according to the satellite navigation system time, the clock of the synchronization module to synchronize with the clock of the combined navigation device. Additionally, since the synchronization module includes multiple input/output ports, the synchronization module may transmit, in the form of message, the satellite navigation system time received in real time to the image collector and the lidar through an input/output port to provide a time service to achieve time synchronization of the image collector and the lidar.

In S402, high-precision map data collected by the data collection device at the target time is acquired.

In S403, the satellite navigation system time corresponding to the target time is determined, and an association between the high-precision map data and the satellite navigation system time is established.

In this embodiment of the present disclosure, based on time synchronization of the image collector and the lidar in S401, after collecting the high-precision map data at the target time, the image collector and the lidar may determine the satellite navigation system time received at the target time for establishing the association between the high-precision map data and the satellite navigation system time.

In this embodiment of the present disclosure, the time of the image collector and the lidar synchronize with the satellite navigation system time through the synchronization module, ensuring the accuracy of the collected high-precision map data.

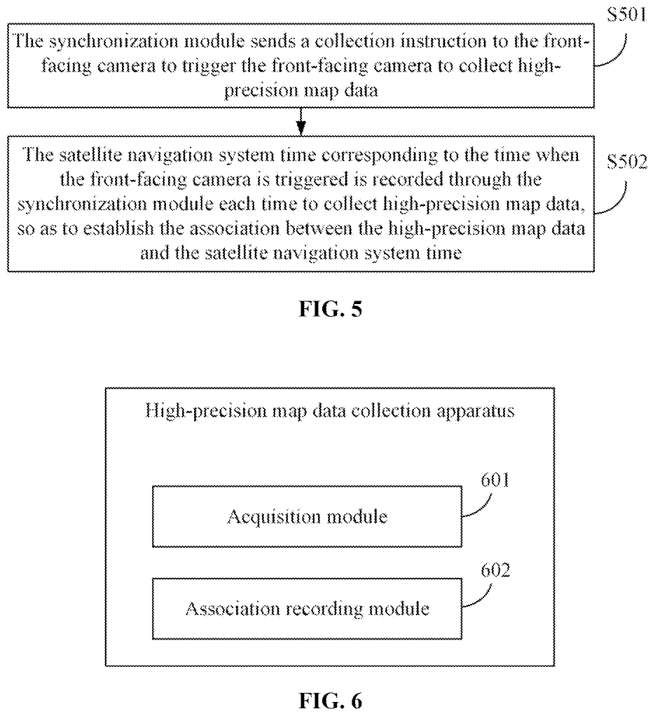

FIG. 5 is a flowchart of another high-precision map data collection method according to an embodiment of the present disclosure. This embodiment of the present disclosure is a refinement of the previous embodiment. Referring to FIG. 5, the high-precision map data collection method is described below.

In S501, the synchronization module sends a collection instruction to the front-facing camera to trigger the front-facing camera to collect high-precision map data.

In S502, the satellite navigation system time corresponding to the time when the front-facing camera is triggered is recorded through the synchronization module each time to collect high-precision map data, so as to establish an association between the high-precision map data and the satellite navigation system time.

According to the previous embodiment, the synchronization module includes multiple input/output ports. Therefore, the synchronization module may control the front-facing camera to collect high-precision map data, for example, control the front-facing camera to shoot at intervals of distance or time. In an implementation, optionally, the synchronization module may send an electrical signal including a collection instruction to the front-facing camera through an input/output port to trigger the front-facing camera to collect high-precision map data. Meanwhile, the synchronization module records the satellite navigation system time corresponding to the time when the front-facing camera is triggered each time to collect high-precision map data, to enable establishment of the association between the high-precision map data and the satellite navigation system time.

In this embodiment of the present disclosure, not only the synchronization module proactively triggers the front-facing camera to work, but the collection time of the high-precision map data also synchronizes with the satellite navigation system time.

FIG. 6 is a diagram illustrating the structure of a high-precision map data collection apparatus according to an embodiment of the present disclosure. This embodiment is applicable to the case of time synchronization of a data collection device. Referring to FIG. 6, the apparatus includes an acquisition module 601 and an association recording module 602.

The acquisition module 601 is configured to acquire high-precision map data collected by a data collection device at a target time.

The association recording module 602 is configured to determine the satellite navigation system time corresponding to the target time and establish an association between the high-precision map data and the satellite navigation system time.

Based on the preceding embodiment, optionally, the data collection device includes an image collector detachably disposed on a first mounting post of a mounting platform and a lidar detachably disposed on a second mounting post of the mounting platform. The image collector includes a front-facing camera and an omnidirectional camera.

Based on the preceding embodiment, optionally, the association recording module is configured to, in the case where the front-facing camera does not support time synchronization, send a message indicating completion of collection of the high-precision map data at the target time to a combined navigation device through the front-facing camera, where the combined navigation device is detachably disposed on a base of the mounting platform and configured to receive the satellite navigation system time in real time through an antenna; and determine, through the combined navigation device, the satellite navigation system time received at the target time and establish the association between the high-precision map data and the satellite navigation system time.

Based on the preceding embodiment, optionally, the association recording module is also configured to, in the case where the omnidirectional camera does not support time synchronization, mark, through a control apparatus, the high-precision map data collected by the omnidirectional camera at the target time and determine the satellite navigation system time uploaded by the combined navigation device at the target time, where the control apparatus is configured to manage the data collection device and the high-precision map data; and establish the association between the high-precision map data and the satellite navigation system time.

Based the preceding embodiment, optionally, the apparatus also includes a time service module configured to, in the case where both the image collector and the lidar support time synchronization, perform time synchronization on the image collector and the lidar through a synchronization module. The synchronization module is configured to receive, in real time, the satellite navigation system time transmitted in real time by the combined navigation device and control, according to the satellite navigation system time, the clock of the synchronization module to synchronize with the clock of the combined navigation device.

Based on the preceding embodiment, optionally, the synchronization module is also configured to send a collection instruction to the front-facing camera to trigger the front-facing camera to collect high-precision map data; and record the satellite navigation system time corresponding to the time when the front-facing camera is triggered each time to collect high-precision map data, to enable establishment of the association between the high-precision map data and the satellite navigation system time.

Based on the preceding embodiment, optionally, the combined navigation device is also configured to acquire position and attitude data and assist, in a preset scenario, in positioning according to wheel speed information fed back by a wheel speedometer.

The high-precision map data collection apparatus according to this embodiment of the present disclosure can perform the high-precision map data collection method according to any embodiment of the present disclosure and has function modules and beneficial effects corresponding to the performed method. For content not described in detail in this embodiment, reference may be made to description in any method embodiment of the present disclosure.

Operations, including acquisition, storage, and application, on a user's personal information involved in the solution of the present disclosure conform to relevant laws and regulations and do not violate the public order and good custom.

According to an embodiment of the present disclosure, the present disclosure also provides an electronic device, a readable storage medium, and a computer program product.

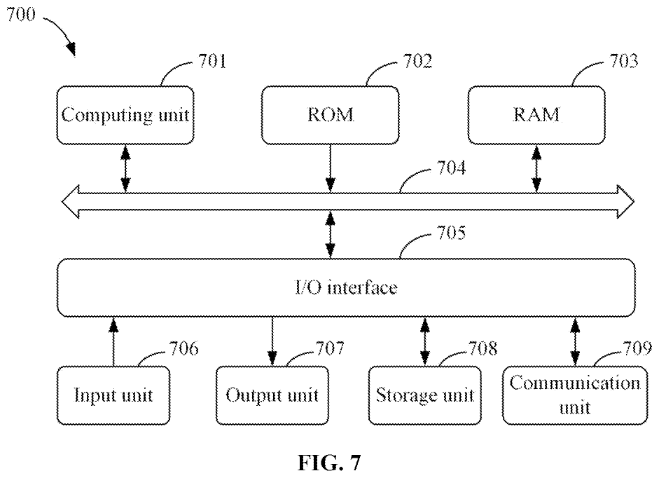

FIG. 7 is a block diagram of an example electronic device 700 for performing an embodiment of the present disclosure. The electronic device is intended to represent various forms of digital computers, for example, a laptop computer, a desktop computer, a workbench, a personal digital assistant, a server, a blade server, a mainframe computer, or another applicable computer. The electronic device may also represent various forms of mobile apparatuses, for example, a personal digital assistant, a cellphone, a smartphone, a wearable device, or a similar computing apparatus. Herein the shown components, the connections and relationships between these components, and the functions of these components are illustrative only and are not intended to limit the implementation of the present disclosure as described and/or claimed herein.

As shown in FIG. 7, the device 700 includes a computing unit 701. The computing unit 701 may perform various appropriate actions and processing according to a computer program stored in a read-only memory (ROM) 702 or a computer program loaded into a random-access memory (RAM) 703 from a storage unit 708. Various programs and data required for the operation of the electronic device 700 may also be stored in the RAM 703. The computing unit 701, the ROM 702, and the RAM 703 are connected to each other through a bus 704. An input/output (I/O) interface 705 is also connected to the bus 704.

Multiple components in the device 700 are connected to the I/O interface 705. The multiple components include an input unit 706 such as a keyboard or a mouse, an output unit 707 such as various types of displays or speakers, the storage unit 708 such as a magnetic disk or an optical disk, and a communication unit 709 such as a network card, a modem or a wireless communication transceiver. The communication unit 709 allows the device 700 to exchange information/data with other devices over a computer network such as the Internet and/or various telecommunications networks.

The computing unit 701 may be various general-purpose and/or special-purpose processing components having processing and computing capabilities. Examples of the computing unit 701 include, but are not limited to, a central processing unit (CPU), a graphics processing unit (GPU), a special-purpose artificial intelligence (AI) computing chip, a computing unit executing machine learning models and algorithms, a digital signal processor (DSP), and any appropriate processor, controller and microcontroller. The computing unit 701 executes various preceding methods and processing, such as the high-precision map data collection method. For example, in some embodiments, the high-precision map data collection method may be implemented as a computer software program tangibly contained in a machine-readable medium such as the storage unit 708. In some embodiments, part or all of computer programs may be loaded and/or installed onto the electronic device 700 via the ROM 702 and/or the communication unit 709. When the computer program is loaded onto the RAM 703 and executed by the computing unit 701, one or more steps of the preceding high-precision map data collection method may be executed. Alternatively, in other embodiments, the computing unit 701 may be configured, in any other suitable manner (for example, by use of firmware), to execute the high-precision map data collection method.

Herein various embodiments of the preceding systems and techniques may be implemented in digital electronic circuitry, integrated circuitry, field-programmable gate arrays (FPGAs), application-specific integrated circuits (ASICs), application-specific standard products (ASSPs), systems on chips (SoCs), complex programmable logic devices (CPLDs), computer hardware, firmware, software, and/or combinations thereof. The various embodiments may include implementations in one or more computer programs. The one or more computer programs are executable and/or interpretable on a programmable system including at least one programmable processor. The programmable processor may be a special-purpose or general-purpose programmable processor for receiving data and instructions from a memory system, at least one input apparatus, and at least one output apparatus and transmitting data and instructions to the memory system, the at least one input apparatus, and the at least one output apparatus.

Program codes for implementation of the methods of the present disclosure may be written in one programming language or any combination of multiple programming languages. The program codes may be provided for the processor or controller of a general-purpose computer, a special-purpose computer, or another programmable data processing apparatus to enable functions/operations specified in flowcharts and/or block diagrams to be implemented when the program codes are executed by the processor or controller. The program codes may be executed entirely on a machine or may be executed partly on a machine. As a stand-alone software package, the program codes may be executed partly on a machine and partly on a remote machine or may be executed entirely on a remote machine or a server.

In the context of the present disclosure, a machine-readable medium may be a tangible medium that may include or store a program that is used by or used in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM) or a flash memory, an optical fiber, a portable compact disc read-only memory (CD-ROM), an optical storage device, a magnetic storage device, or any suitable combination thereof.

In order that interaction with a user is provided, the systems and techniques described herein may be implemented on a computer. The computer has a display apparatus (for example, a cathode-ray tube (CRT) or a liquid-crystal display (LCD) monitor) for displaying information to the user and a keyboard and a pointing apparatus (for example, a mouse or a trackball) through which the user can provide input to the computer. Other types of apparatuses may also be used for providing interaction with a user. For example, feedback provided for the user may be sensory feedback in any form (for example, visual feedback, auditory feedback, or haptic feedback). Moreover, input from the user may be received in any form (including acoustic input, voice input, or haptic input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with implementations of the systems and techniques described herein), or a computing system including any combination of such back-end, middleware or front-end components. Components of a system may be interconnected by any form or medium of digital data communication (for example, a communication network). Examples of the communication network include a local area network (LAN), a wide area network (WAN) and the Internet.

A computing system may include a client and a server. The client and the server are usually far away from each other and generally interact through the communication network. The relationship between the client and the server arises by virtue of computer programs running on respective computers and having a client-server relationship to each other. The server may be a cloud server, a server of a distributed system, or a server combined with a blockchain.

It is to be understood that various forms of the preceding flows may be used with steps reordered, added, or removed. For example, the steps described in the present disclosure may be executed in parallel, in sequence or in a different order as long as the desired results of the technical solutions disclosed in the present disclosure can be achieved. The execution sequence of these steps is not limited herein.

The scope of the present disclosure is not limited to the preceding embodiments. It is to be understood by those skilled in the art that various modifications, combinations, subcombinations, and substitutions may be made according to design requirements and other factors. Any modification, equivalent substitution, improvement and the like made within the spirit and principle of the present disclosure falls within the scope of the present disclosure.

What is claimed is:

1. A high-precision map data collection method, comprising:
acquiring high-precision map data collected by a data collection device at a target time; and
determining a satellite navigation system time corresponding to the target time and establishing an association between the high-precision map data and the satellite navigation system time.

2. The method of claim 1, wherein the data collection device comprises an image collector detachably disposed on a first mounting post of a mounting platform and a lidar detachably disposed on a second mounting post of the mounting platform, wherein the image collector comprises a front-facing camera and an omnidirectional camera.

3. The method of claim 2, wherein determining the satellite navigation system time corresponding to the target time and establishing the association between the high-precision map data and the satellite navigation system time comprise:
in a case where the front-facing camera does not support time synchronization, sending a message indicating completion of collection of the high-precision map data at the target time to a combined navigation device through the front-facing camera, wherein the combined navigation device is detachably disposed on a base of the mounting platform and receives the satellite navigation system time in real time through an antenna; and
determining, through the combined navigation device, the satellite navigation system time received at the target time and establishing the association between the high-precision map data and the satellite navigation system time.

4. The method of claim 3, wherein determining the satellite navigation system time corresponding to the target time and establishing the association between the high-precision map data and the satellite navigation system time comprise:
in a case where the omnidirectional camera does not support time synchronization, marking, through a control apparatus, the high-precision map data collected by the omnidirectional camera at the target time and determining the satellite navigation system time uploaded by the combined navigation device at the target time, wherein the control apparatus is configured to manage the data collection device and the high-precision map data; and
establishing the association between the high-precision map data and the satellite navigation system time.

5. The method of claim 3, further comprising:
in a case where both the image collector and the lidar support time synchronization, performing time synchronization on the image collector and the lidar through a synchronization module, wherein the synchronization module receives, in real time, the satellite navigation system time transmitted in real time by the combined navigation device and control, according to the satellite navigation system time, a clock of the synchronization module to synchronize with a clock of the combined navigation device.

6. The method of claim 5, further comprising:
sending, through the synchronization module, a collection instruction to the front-facing camera to trigger the front-facing camera to collect high-precision map data; and
recording, through the synchronization module, a satellite navigation system time corresponding to a time when the front-facing camera is triggered each time to collect the high-precision map data so as to establish the association between the high-precision map data and the satellite navigation system time.

7. The method of claim 3, wherein the combined navigation device is further configured to acquire position and attitude data and assist, in a preset scenario, in positioning according to wheel speed information fed back by a wheel speedometer.

8. A high-precision map data collection apparatus, comprising: at least one processor; and a memory communicatively connected to the at least one processor, the memory stores instructions executable by the at least one processor to enable the at least one processor to perform steps in the following modules:
an acquisition module configured to acquire high-precision map data collected by a data collection device at a target time; and
an association recording module configured to determine a satellite navigation system time corresponding to the target time and establish an association between the high-precision map data and the satellite navigation system time.

9. The apparatus of claim 8, wherein the data collection device comprises an image collector detachably disposed on a first mounting post of a mounting platform and a lidar detachably disposed on a second mounting post of the mounting platform, wherein the image collector comprises a front-facing camera and an omnidirectional camera.

10. The apparatus of claim 9, wherein the association recording module is configured to:
in a case where the front-facing camera does not support time synchronization, send a message indicating completion of collection of the high-precision map data at the target time to a combined navigation device through the front-facing camera, wherein the combined navigation device is detachably disposed on a base of the mounting platform and receives the satellite navigation system time in real time through an antenna; and
determine, through the combined navigation device, the satellite navigation system time received at the target time and establish the association between the high-precision map data and the satellite navigation system time.

11. The apparatus of claim 10, wherein the association recording module is further configured to:
in a case where the omnidirectional camera does not support time synchronization, mark, through a control apparatus, the high-precision map data collected by the omnidirectional camera at the target time and determine the satellite navigation system time uploaded by the combined navigation device at the target time, wherein the control apparatus is configured to manage the data collection device and the high-precision map data; and
establish the association between the high-precision map data and the satellite navigation system time.

12. The apparatus of claim 10, further comprising:
a time service module configured to, in a case where both the image collector and the lidar support time synchronization, perform time synchronization on the image collector and the lidar through a synchronization module, wherein the synchronization module is configured to receive, in real time, the satellite navigation system time transmitted in real time by the combined navigation device and control, according to the satellite navigation system time, a clock of the synchronization module to synchronize with a clock of the combined navigation device.

13. The apparatus of claim 12, wherein the synchronization module is further configured to:
send a collection instruction to the front-facing camera to trigger the front-facing camera to collect high-precision map data; and
record a satellite navigation system time corresponding to a time when the front-facing camera is triggered each time to collect the high-precision map data, to enable establishment of the association between the high-precision map data and the satellite navigation system time.

14. The apparatus of claim 10, wherein the combined navigation device is further configured to acquire position and attitude data and assist, in a preset scenario, in positioning according to wheel speed information fed back by a wheel speedometer.

15. A non-transitory computer-readable storage medium storing computer instructions for causing a computer to perform the following steps:
acquiring high-precision map data collected by a data collection device at a target time; and
determining a satellite navigation system time corresponding to the target time and establishing an association between the high-precision map data and the satellite navigation system time.

16. The storage medium of claim 15, wherein the data collection device comprises an image collector detachably disposed on a first mounting post of a mounting platform and a lidar detachably disposed on a second mounting post of the mounting platform, wherein the image collector comprises a front-facing camera and an omnidirectional camera.

17. The storage medium of claim 16, wherein determining the satellite navigation system time corresponding to the target time and establishing the association between the high-precision map data and the satellite navigation system time comprise:
in a case where the front-facing camera does not support time synchronization, sending a message indicating completion of collection of the high-precision map data at the target time to a combined navigation device through the front-facing camera, wherein the combined navigation device is detachably disposed on a base of the mounting platform and receives the satellite navigation system time in real time through an antenna; and
determining, through the combined navigation device, the satellite navigation system time received at the target time and establishing the association between the high-precision map data and the satellite navigation system time.

18. The storage medium of claim 17, wherein determining the satellite navigation system time corresponding to the target time and establishing the association between the high-precision map data and the satellite navigation system time comprise:
in a case where the omnidirectional camera does not support time synchronization, marking, through a control apparatus, the high-precision map data collected by the omnidirectional camera at the target time and determining the satellite navigation system time uploaded by the combined navigation device at the target time, wherein the control apparatus is configured to manage the data collection device and the high-precision map data; and
establishing the association between the high-precision map data and the satellite navigation system time.

19. The storage medium of claim 17, wherein the computer instruction is further configured to cause the computer to perform the following steps:
in a case where both the image collector and the lidar support time synchronization, performing time synchronization on the image collector and the lidar through a synchronization module, wherein the synchronization module receives, in real time, the satellite navigation system time transmitted in real time by the combined navigation device and control, according to the satellite navigation system time, a clock of the synchronization module to synchronize with a clock of the combined navigation device.

20. The storage medium of claim 19, wherein the computer instruction is further configured to cause the computer to perform the following steps:
sending, through the synchronization module, a collection instruction to the front-facing camera to trigger the front-facing camera to collect high-precision map data; and
recording, through the synchronization module, a satellite navigation system time corresponding to a time when the front-facing camera is triggered each time to collect the high-precision map data so as to establish the association between the high-precision map data and the satellite navigation system time.
